(19) United States
(12) Patent Application Publication
(10) Pub. No.: US 2004/0205632 A1
(43) Pub. Date: Oct. 14, 2004

(54) Electronic book

(76) Inventor: Tung-Liang Li, Taichung (TW)

Correspondence Address: Tung-Liang Li, 58, MA YUAN WEST ST., TAICHUNG, TW

(21) Appl. No.: 10/028,178

(22) Filed: Dec. 21, 2001

(51) Int. Cl. G06F 17/24; G06F 17/21

(52) U.S. Cl. 715/526; 715/530

(57) ABSTRACT

The present invention relates to an electronic book, wherein dot bmk files may be built according to related data of an abstract, a viewpoint, an underline, a manual note or the like that are made when a reader is reading the electronic book. All of the original text files of the electronic book are not changed. When the reader is reading the electronic book, the original text file may first be read, and the related data file of the dot bmk file may then be read. The original text file and the dot bmk file may exist on the monitor simultaneously, and may exist on the monitor individually.

### BACKGROUND OF THE INVENTION

1. Field of the Invention

The present invention relates to an electronic book, and more particularly to an electronic book, wherein the reader may build the dot bmk files containing the abstract, viewpoint, note or the like that are made when the reader is reading the electronic book. In addition, the contents of the book mark, the underline, the highlight and the manual note may be amended, deleted and added arbitrarily.

2. Description of the Related Art

A conventional electronic book cannot make the contents of the original texts into the book mark, the underline, the highlight, the manual note or the like. Thus, if the reader makes the abstract, viewpoint, note or the like when he/she is reading the electronic book, the data of the abstract, viewpoint, note or the like cannot be stored in the electronic book, so that the data may be lost, thereby causing inconvenience to the reader if the data cannot be stored in the electronic book.

### SUMMARY OF THE INVENTION

The present invention has arisen to mitigate and/or obviate the disadvantage of the conventional electronic book.

The primary objective of the present invention is to provide an electronic book, wherein the reader may build the dot bmk files containing the related data of the book mark, underline, highlight, manual note, abstract, viewpoint or the like that are made when the reader is reading the electronic book. In addition, the contents of the book mark, the underline, the highlight and the manual note may be amended, deleted and added arbitrarily.

Another objective of the present invention is to provide an electronic book, wherein all of the original text file of the electronic book are not changed. When the reader is reading the electronic book, the original text file may first be read, and the related data file of the dot bmk file may then be read. The original text file and the dot bmk file may exist on the monitor simultaneously, and may exist on the monitor individually.

In accordance with the present invention, there is provided an electronic book, wherein dot bmk files may be built according to the related data of the book mark, underline, highlight, manual note, abstract, viewpoint or the like that are made when a reader is reading the electronic book. All of the original text files of the electronic book are not changed. When the reader is reading the electronic book, the original text file may first be read, and the related data file of the dot bmk file may then be read. The original text file and the dot bmk file may exist on the monitor simultaneously, and may exist on the monitor individually.

Preferably, the dot bmk file contains a book mark, an underline, a highlight, a manual note and the like.

Preferably, the related data of the dot bmk file may be amended, deleted and added arbitrarily.

The electronic book comprises the following procedures:

(a) executing a main program;

(b) reading out the original text file and the dot bmk (.bmk) file;

(c) reading if the data file related to the book mark exists in the dot bmk file;

(d) reading in the data file related to the book mark;

(e) reading if the data file related to the underline exists in the dot bmk file;

(f) reading in the data file related to the underline;

(g) reading if the data file related to the highlight exists in the dot bmk file;

(h) reading in the data file related to the highlight; and

(i) entering the reading mode.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of an electronic book in accordance with a preferred embodiment of the present invention.

### DETAILED DESCRIPTION OF THE INVENTION

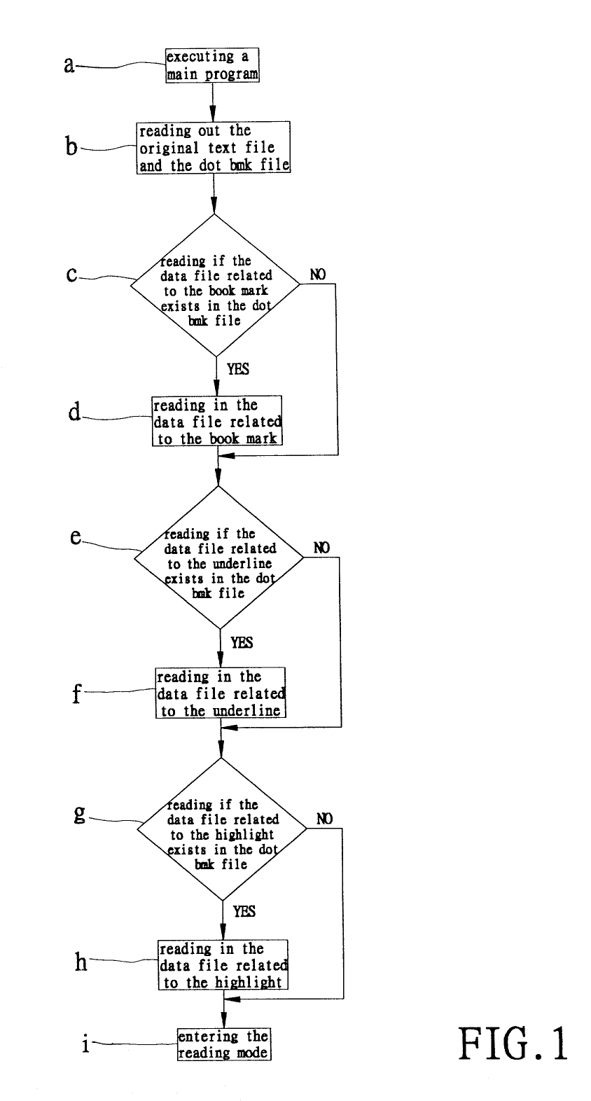

Referring to FIG. 1, an electronic book in accordance with a preferred embodiment of the present invention comprises the following procedures:

(a) executing the main program;

(b) reading out the original text file and the dot bmk (.bmk) file;

(c) reading if the data file related to the book mark exists in the dot bmk file;

(d) reading in the data file related to the book mark;

(e) reading if the data file related to the underline exists in the dot bmk file;

(f) reading in the data file related to the underline;

(g) reading if the data file related to the highlight exists in the dot bmk file;

(h) reading in the data file related to the highlight; and

(i) entering the reading mode.

Accordingly, the electronic book in accordance with the preferred embodiment of the present invention has the following advantages.

1. By the electronic book of the present invention, the reader may build the dot bmk files containing the abstract, viewpoint, note or the like that are made when the reader is reading the electronic book. In addition, the contents of the book mark, the underline, the highlight and the manual note may be amended, deleted and added arbitrarily.

2. All of the original text file of the electronic book are not changed. When the reader is reading the electronic book, the original text file may first be read, and the related data file of the dot bmk file may then be read. The original text file and the dot bmk file may exist on the monitor simultaneously, and may exist on the monitor individually.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An electronic book, wherein: dot bmk files may be built according to related data of an abstract, a viewpoint, an underline, a manual note or the like that are made when a reader is reading the electronic book, all of the original text files of the electronic book are not changed, when the reader is reading the electronic book, the original text file may first be read, and the related data file of the dot bmk file may then be read, the original text file and the dot bmk file may exist on the monitor simultaneously, and may exist on the monitor individually.

2. The electronic book in accordance with claim 1, wherein the dot bmk file contains a book mark, an underline, a highlight, a manual note and the like.

3. The electronic book in accordance with claim 1, wherein the related data of the dot bmk file may be amended, deleted and added arbitrarily.

4. The electronic book in accordance with claim 1, wherein the electronic book comprises the following procedures:
(a) executing a main program;
(b) reading out the original text file and the dot bmk file;
(c) reading if the data file related to the book mark exists in the dot bmk file;
(d) reading in the data file related to the book mark;
(e) reading if the data file related to the underline exists in the dot bmk file;
(f) reading in the data file related to the underline;
(g) reading if the data file related to the highlight exists in the dot bmk file;
(h) reading in the data file related to the highlight; and
(i) entering the reading mode.
